(19) United States
(12) Patent Application Publication
(10) Pub. No.: US 2012/0246305 A1
(43) Pub. Date: Sep. 27, 2012

(54) SYSTEM AND METHOD FOR MANAGEMENT OF COTS DEVICES IN MANAGED NETWORKS BASED ON DEVICE AUTO-DETECTION

(75) Inventors: Shanti Swarup Vedula, Boyds, MD (US); Robert Torres, New Market, MD (US); Gaurav Sabharwal, Urbana, MD (US); Patrick Fisher, Gaithersburg, MD (US); Chaitali Ghosalkar, Falls Church, VA (US); William Highfield, Gaithersburg, MD (US)

(73) Assignee: Hughes Network Systems, LLC, Germantown, MD (US)

(21) Appl. No.: 13/428,147

(22) Filed: Mar. 23, 2012

Related U.S. Application Data
(60) Provisional application No. 61/466,782, filed on Mar. 23, 2011.

(51) Int. Cl. G06F 15/173

(52) U.S. Cl. 709/224

(57) ABSTRACT

A system and method for managing COTS devices based on device auto-detection and identification is provided. A network device on a managed network is identified, wherein the network device is identified as a one of a list of one or more network device types supported by the managed network and included in one or more configuration files, and wherein the one or more configuration files further include a list of one or more respective SNMP variables to be monitored for each of the network device types. The respective listing of SNMP variables to be monitored and/or configured is extracted from the one or more configuration files for the identified network device type. A request is then generated to monitor and/or configure the extracted SNMP variables to be monitored for the network device.

### RELATED APPLICATIONS

This application is related to and claims the benefit of priority under 35 U.S.C. §119(e) to U.S. Provisional Application Ser. No. 61/466,782 filed Mar. 23, 2011, the entirety of which is incorporated herein by reference.

### FIELD OF THE INVENTION

The present invention relates to a system and method for monitoring of status and statistics information, and automatic configuration, of devices in managed networks.

### BACKGROUND OF THE INVENTION

Virtual Private Networks (VPNs) are frequently used to connect an enterprise network to remote sites. A VPN establishes an encrypted data connection between a central site and remote sites using a public or foreign network, such as the Internet, as an intermediary data link. A VPN allows devices within a remote site to seamlessly interact with devices in the central site or another remote site, as if they were locally situated. A VPN router is used to establish such a connection between a network at the remote site, and the central site, by providing secure broadband access to the end-users over a terrestrial broadband network. The VPN router traditionally connects to a VPN gateway at a Network Operations Center (NOC) through a third party Network Access Provider (NAP) network via a transport device, such as a DSL, T1, wireless, cable, or satellite modem. The type of modem, a component-off-the-shelf (COTS) device, installed at the remote site depends on, e.g., the customer requirements, cost, and service availability from different vendors in different geographical regions.

An administrator of a managed network may frequently require the ability to monitor, from the NOC, the status and statistics of devices attached to the VPN router. One such device that is of interest to an administrator of a VPN network is the transport device (e.g., modem) attached to the VPN router. This may be accomplished using Simple Network Management Protocol (SNMP), a common standard protocol used for monitoring network-attached devices. SNMP allows a network administrator to monitor a SNMP-enabled device for any issues which require attention. It is noted that the terms “administrator” and “operator” are interchangeably used herein.

However, monitoring of the modem's status/statistics is complicated by the fact that the type of modem (DSL, wireless, cable, etc.) installed at each remote site could be different and the administrator may not always be aware of the particular manufacturer and model of the modem installed at the remote site. Furthermore, although quite a few of the statistics are common to all types of devices, some of them are specific only to a particular type of device. For example, “Receive Signal Strength Indicator” is applicable only to a wireless modem, whereas the number of ATM cells transmitted and received statistics are applicable to a DSL modem.

An additional concern facing customary SNMP monitoring is that often, an administrator does not need to review all the status and statistics information that is obtainable, but may only be interested in particularly important status and statistics information from a device.

One approach is to configure a VPN router to send an HTTP request to the attached modem and to parse the response to extract the status and statistics information. The information is then sent back to the NOC. However, this approach has several deficiencies. First, it reports all the status and statistics information of the modem, not just a select few (i.e., subset) that the operator is interested in. Also, the approach is not easily extensible to adding newer devices as there is a need to know the URLs and the web content, all of which could potentially change over time as new status/statistics are added. Finally, introduction of a new type of device could necessitate a new set of statistics and might even require a software change in the VPN router to facilitate the HTML parsing.

Another approach to monitoring the modem is to configure each VPN router (often via scripting) with a set of the attached device's status/statistics to be monitored via SNMP. However, each script needs to be tailored for the specific device type and therefore requires a priori knowledge of the device installed at each site. Furthermore, addition of a new statistic or any modification would require re-scripting. Also, if a site's device is replaced with a different type of device (e.g., a DSL modem is replaced with a cable or wireless modem), re-scripting is again required. Without the help of a graphical user interface, manual editing of the scripts specifying the SNMP status/statistics (i.e., scripts specifying the SNMP OIDs) can be both cumbersome and error-prone.

Another environment where an administrator of a managed network may frequently require the ability to monitor, from a NOC, the status and statistics of devices at a remote site, is a satellite network. In a satellite network, a component connected on the remote site's LAN, such as an Analog Telephone Adapter (ATA) may be desired to be monitored for certain performance statistics. The ATA customarily is a third party COTS component providing Voice over IP (VoIP) services at the enterprise site.

The actual ATA device (e.g., manufacturer and model) installed at the remote site depends on, e.g., the cost, availability, and the feature set offered by the device. Monitoring the status/statistics of the ATA devices is very similar to that of transport device monitoring in a VPN environment and may actually be realistically simpler. In contrast to the transport devices where the status/statistics vary widely with the type of the device, the ATA status/statistics, other than the difference in SNMP variables (e.g., object identifiers), do not vary much from device to device. However, an operator at a NOC may not always be aware of the particular manufacturer and model of ATA installed at the remote site.

In both a VPN system and a satellite system, Customer Premise Equipment (CPE) devices may be designated to monitor connected devices. In a VPN system, the CPE device may be the VPN router. In a satellite system, the CPE device may be a Very Small Aperture Terminal (VSAT).

It is clear from both the scenarios of a VPN system and of a satellite system that the issue of efficiently monitoring a remote site is generic in nature. That is, the concern relates to the monitoring the status/statistics of a third party class of off-the-shelf devices (e.g., ATAs, transport modems, etc.) attached to a CPE device (such as a VPN router, a VSAT, etc.) in a managed (e.g., terrestrial, satellite, etc.) network with no a priori knowledge of the actual device installed at the remote site.

What is needed is a flexible and convenient approach for managing customer premise devices within a managed network, for operator-configured device status and statistics, irrespective of the type of device and without requiring a priori knowledge thereof, such that monitoring by a network manager of the status/statistics of the device displays only the relevant operator configured status/statistics for the particular device installed at the customer site.

### SUMMARY OF THE INVENTION

The present invention advantageously addresses the foregoing requirements and needs, as well as others, by providing a system and method for managing customer premise devices within a managed network, for operator-configured device status and statistics, irrespective of the type of device and without requiring a priori knowledge thereof.

According to an exemplary embodiment, a method for managing customer premise devices within a managed network comprises identifying a network device on a managed network, wherein the network device is identified as a one of a list of one or more network device types supported by the managed network and included in one or more configuration files, and wherein the one or more configuration files further include a list of one or more respective SNMP variables to be monitored for each of the network device types. The method further comprises extracting the respective listing of SNMP variables to be monitored from the one or more configuration files for the identified network device type. A request is then generated to monitor the extracted SNMP variables of the network device. Additionally, the configuration file may further include a listing of one or more respective SNMP variables to be configured for each of the network device types listed in the configuration file, and the method further comprises extracting the respective listing of SNMP variables to be configured from the one or more configuration files for the identified network device type. A request is then generated to configure the extracted SNMP variables to be configured for the network device. According to a further exemplary embodiment of the method, a device file is received for each of the network device types supported by the managed network, wherein each device file is compiled from an SNMP management information base (MIB) file for the respective network device type. Further, a selection, based on a selection of respective device files, of one or more network devices to be monitored and/or configured is received, and a selection of SNMP variables for each of the network devices to be monitored and/or configured is also received. Moreover, the configuration file is generated based on the selected SNMP variables for each of the network devices to be monitored and/or configured.

According to another exemplary embodiment, an apparatus comprises at least one processor, and at least one memory including computer program code for one or more programs, wherein the at least one memory and the computer program code are configured to, with the at least one processor, cause the apparatus to perform certain steps. The apparatus is caused to identify a network device on a managed network, wherein the network device is identified as a one of a list of one or more network device types supported by the managed network and included in one or more configuration files, and wherein the one or more configuration files further include a list of one or more respective SNMP variables to be monitored for each of the network device types. The apparatus is further caused to extract the respective listing of SNMP variables to be monitored from the one or more configuration files for the identified network device type. The apparatus is then caused to generate a request to monitor the extracted SNMP variables to be monitored for the network device. Additionally, the configuration file may further include a listing of one or more respective SNMP variables to be configured for each of the network device types listed in the configuration file, and the apparatus is further caused to extract the respective listing of SNMP variables to be configured from the one or more configuration files for the identified network device type. The apparatus is then caused to generate a request to configure the extracted SNMP variables to be configured for the network device.

According to another exemplary embodiment, a system comprises a local device and a network manager device. The local device comprises at least one processor, and at least one memory including computer program code for one or more programs, the at least one memory and the computer program code configured to, with the at least one processor, cause the local device to perform certain steps. The local device is caused to identify a network device on a managed network, wherein the network device is identified as a one of a list of one or more network device types supported by the managed network and included in one or more configuration files, and wherein the one or more configuration files further include a list of one or more respective SNMP variables to be monitored and/or configured for each of the network device types. The local device is further caused to extract the respective listing of SNMP variables to be monitored and/or configured from the one or more configuration files for the identified network device type. The local device is then caused to generate a request to monitor and/or configure the extracted SNMP variables to be monitored and/or configured for the network device. The network manager device comprises at least one processor, and at least one memory including computer program code for one or more programs, the at least one memory and the computer program code configured to, with the at least one processor, cause the local device to perform certain steps. The network manager device is caused to receive a device file for each of the network device types supported by the managed network, wherein each device file is compiled from an SNMP management information base (MIB) file for the respective network device type. The network manager device is further caused to receive a selection, based on a selection of respective device files, of one or more network devices to be monitored and/or configured, and to receive a selection of SNMP variables for each of the network devices to be monitored and/or configured. The network manager device is then caused to generate the configuration file based on the selected SNMP variables for each of the network devices to be monitored and/or configured.

Still other aspects, features, and advantages of the present invention are readily apparent from the following detailed description, simply by illustrating a number of particular embodiments and implementations, including the best mode contemplated for carrying out the present invention. The present invention is also capable of other and different embodiments, and its several details can be modified in various obvious respects, all without departing from the spirit and scope of the present invention. Accordingly, the drawing and description are to be regarded as illustrative in nature, and not as restrictive.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates a schematic diagram showing a VPN system, in accordance with an exemplary embodiment;

FIG. 2 illustrates a schematic diagram showing a satellite system, in accordance with an exemplary embodiment;

FIG. 3 illustrates a schematic diagram of a VPN router, in accordance with an exemplary embodiment;

FIG. 4 illustrates a diagram showing a conceptual layout of SNMP storage, in accordance with an exemplary embodiment;

FIG. 5 illustrates a diagram showing a conceptual layout of a transport device statistics management information base table, in accordance with an exemplary embodiment;

FIG. 6 illustrates a schematic diagram of a NOC monitoring apparatus, in accordance with an exemplary embodiment;

FIGS. 7A and 7B illustrate flow charts showing operation of auto configuration and monitoring processes, in accordance with exemplary embodiments;

FIG. 8 illustrates a flow chart showing operation of a retrieval of SNMP transport device statistics data from a customer premise device, in accordance with an exemplary embodiment;

FIG. 9 illustrates selection of SNMP variables for a Siemens Subscriber Network 4100-series DSL modem, in accordance with an exemplary embodiment;

FIG. 10 illustrates selection of SNMP variables for a Raven X modem, in accordance with an exemplary embodiment;

FIGS. 11A and 11B illustrate configuration files, in accordance with exemplary embodiments;

FIG. 12 illustrates an SNMP status/statistics display, in accordance with an exemplary embodiment;

FIG. 13 illustrates a computer system on which a system and method for managing customer premise devices within a managed network may be implemented, according to exemplary embodiments; and

FIG. 14 illustrates a chip set that can be used to implement exemplary embodiments.

### DETAILED DESCRIPTION OF THE PREFERRED EMBODIMENTS

A system and method a system and method for managing customer premise devices within a managed network, for operator-configured device status and statistics, irrespective of the type of device and without requiring a priori knowledge thereof, is described. In the following description, for the purposes of explanation, numerous specific details are set forth in order to provide a thorough understanding of the invention. It is apparent, however, that the invention may be practiced without these specific details or with an equivalent arrangement. In other instances, well known structures and devices are shown in block diagram form in order to avoid unnecessarily obscuring the invention.

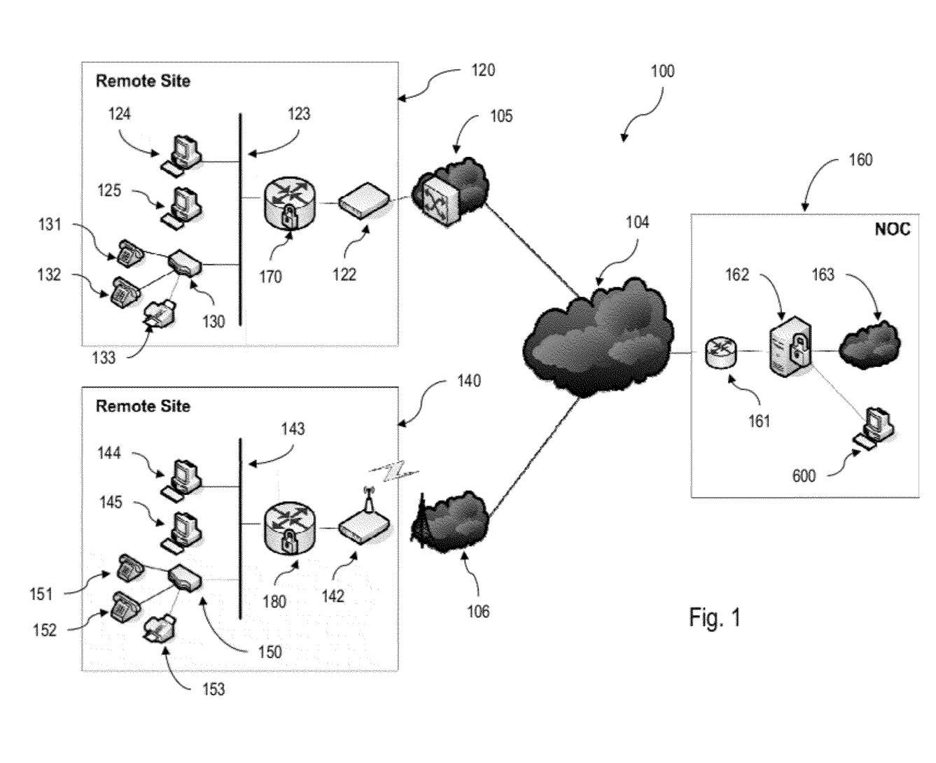

FIG. 1 illustrates a VPN system 100 in accordance with an exemplary embodiment of the present invention. VPN system 100 includes a Network Operations Center (NOC) 160 and at least one remote site. In the example of FIG. 1, there are two remote sites 120 and 140. However, it will be appreciated that VPN system 100 may be configured with a single remote site or with more than two remote sites.

The NOC includes a router 161, a VPN gateway 162, an enterprise network 163, and a monitoring apparatus 600. Router 161 routes data between the Internet 104 and VPN gateway 162, which in turn, provides VPN access to enterprise network 163. The monitoring apparatus 600 is connected to VPN gateway 162 via a management interface (e.g., dedicated network interface), and configures VPN routers 170 and 180 for monitoring, and also polls VPN routers 170 and 180 for SNMP status/statistics information, as will be later described.

The remote site 120 includes a VPN router 170, a Digital Subscriber Line (DSL) modem 122, and a local area network (LAN) 123. LAN 123 interconnects VPN router 170 with various devices, such as computers 124 and 125, and an Analog Telephone Adapter (ATA) 130. The ATA 130 is a component that provides Voice over IP (VoIP) services with the enterprise network 163 (i.e., between remote site 120 and enterprise network 163). ATA 130 allows connectivity of phone-related components, such as telephones 131 and 132, a fax machine 133, or any other components which connect over a phone line. The DSL modem 122 provides connectivity between VPN router 170 and a Network Access Provider (NAP) network 105. NAP network 105 contains various components, for example, a DSL Access Multiplexer (DSLAM), for connecting remote site 120 to the Internet 104.

Remote site 140 includes a VPN router 180, wireless modem 142, and a LAN 143. LAN 143 interconnects VPN router 180 with various devices, such as computers 144 and 145, and an ATA 150. ATA 150 allows connectivity of phone-related components, such as telephones 151 and 152, a fax machine 153, or any other components which connect over a phone line. The wireless modem 142 provides connectivity between VPN router 180 and a NAP network 106. The NAP network contains various components, for example, a wireless transceiver, for connecting remote site 140 to the Internet 104.

Monitoring Component

As seen in FIG. 1, remote sites 120 and 140 contain different classes of component off-the-shelf (COTS) devices to be monitored. In particular, remote site 120 contains two classes of COTS devices: (1) transport devices; and (2) ATA devices. DSL modem 122, attached to VPN router 170, belongs to the transport-device class of COTS devices, while ATA 130, attached to VPN router 170, belongs to the ATA-device class of COTS devices. Further, at remote site 140, wireless modem 142, attached to VPN router 180, belongs to the transport-device class COTS devices, while ATA 150, attached to the VPN router 180, belongs to the ATA-device class of COTS devices.

According to an exemplary embodiment, a mechanism is provided, such that, when the administrator of system 100 at NOC 160 views the status/statistics of the transport device associated with the remote site 120, only the status/statistics that are relevant to the specific manufacturer and model of the DSL modem 122 are displayed. Similarly, a status/statistics view of the transport device associated with remote site 140 would only display the status/statistics relevant to the specific manufacturer and model of the wireless modem 142.

According to a further exemplary embodiment, a mechanism is provided, such that, when the administrator at NOC 160 views the status/statistics of the ATA device associated with remote site 120, only the status/statistics that are relevant to ATA 130 are displayed, irrespective of the manufacturer and model of the ATA. Similarly, a status/statistics view of the ATA associated with remote site 140 would only display the status/statistics relevant to ATA 150.

Because the COTS devices (i.e., DSL modem 122 and ATA 130, for remote site 120) themselves may or may not be directly reachable from the NOC 160, a component (e.g., VPN router 170) at a remote site may be enabled to perform monitoring of devices connected to it. For instance, at remote site 120, VPN router 170 may perform monitoring of status/statistics information for DSL modem 122, and/or for devices connected to LAN 123 (e.g., ATA 130). At remote site 140, VPN router 180 may perform monitoring of status/statistics information for wireless router 142, and/or for devices connected to LAN 143 (e.g., ATA 150). Such a component, which performs monitoring of connected devices, will hereinafter be generically referred to as a Customer Premise Equipment (CPE) device. In system 100, VPN routers 170 and 180 may be the CPE devices at remote sites 120 and 140, respectively. It will be appreciated, however, that the invention is not limited to such components serving as the CPE, device but that any component capable of monitoring devices may serve as a CPE device.

Customer Premise Equipment (CPE) Device

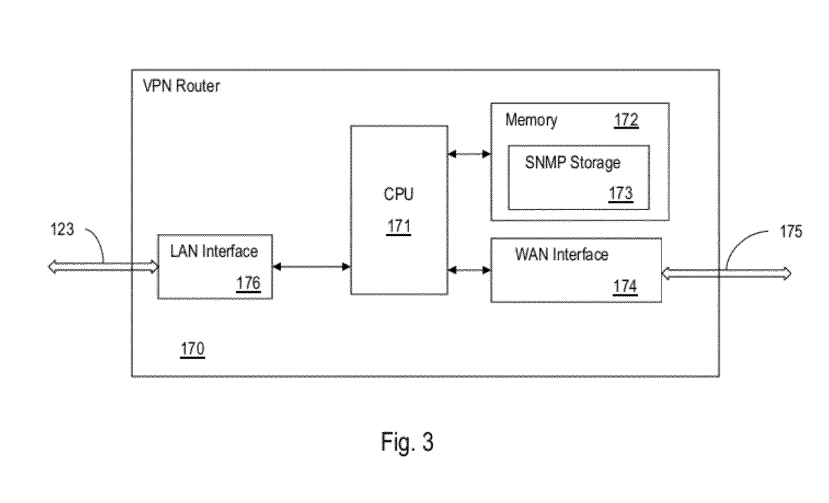

The construction of a CPE device, according to an exemplary embodiment, will now be described, for example, with respect to remote site 120. FIG. 3 depicts a block diagram of the features of VPN router 170, serving as a CPE device for remote site 120. VPN router 170 includes a CPU 171 and a hardware memory 172. Memory 172 preferably includes both flash memory and RAM, but may alternatively or additionally include other data storage, such as ROM or hard disk. Unless specified otherwise, all functions of and actions taken by VPN router 170 are effected by execution, by CPU 171, of programming code instructions stored in memory 172. VPN router 170 also includes a LAN interface 176 and a wide area network (WAN) interface 174.

LAN interface 176 is connected to the LAN 123, such as in an Ethernet network. As discussed above, LAN 123 is attached to networked devices including computers 124 and 125, and ATA 130. It will be appreciated, however, that networked devices are not limited to such, and can also include printers, scanners, copiers, VoIP devices, or any other network-enabled electronic device, as previously described with respect to FIG. 1. These devices send and receive data over LAN 123. Such devices will hereinafter be generically referred to as component off-the-shelf (COTS) application devices. Alternatively, it will be understood that any form of data connectivity other than a LAN may be used, as long as data is transferred between VPN router 170 and the devices.

WAN interface 174 is connected to a data link 175, which connects VPN router 170 with DSL modem 122, as seen in FIG. 1. DSL modem 122, in turn, is connected to a NAP network 105, as seen in FIG. 1. NAP network 105 is customarily a third party NAP network, which provides connectivity to the Internet. As such, WAN interface 174 allows access to NAP network 105 and to the Internet 104. DSL modem 122 is referred to herein as a COTS transport device. VPN router 170 is operable to manage the transfer of data between WAN interface 174 and COTS application devices on LAN 123. That is, VPN router 170 routes data sent from a COTS application device on LAN 123 having a destination which is only accessible via WAN interface 174, and further routes data received from WAN interface 174 having a destination of a COTS application device on LAN 123. It is noted that, unless specifically otherwise described, the term “COTS device” refers to both COTS application devices on the LAN and the COTS transport devices on the WAN.

Memory 172 includes an SNMP storage 173 for storing SNMP content. SNMP storage 173 stores configuration and status/statistics information relating to polled SNMP variables of COTS devices attached via LAN interface 176 or WAN interface 174, which have been selected to be monitored.

SNMP, including SNMP storage 173, will now be described in further detail. One or more of the COTS devices attached via LAN interface 176 (i.e., on LAN 123) and/or via WAN interface 174 may be SNMP-enabled. That is, such a COTS device has the capability, in accordance with the SNMP protocol, to monitor particular status and/or operational statistics, and to provide such status/statistic data, upon request. Such status/statistics may include, for example, a device identifier, hardware type, IP address, packet loss and/or retransmit statistics, data throughput speed, send and receive signal strength (e.g., for a wireless device), or any other potentially relevant information that is compatible with SNMP. Each different status/statistic is known as an SNMP variable.

At remote site 120, for example, as a device attached via LAN interface 176, ATA 130 is SNMP enabled. As a device attached via WAN interface 174, DSL modem 122 is also SNMP enabled, for example. When the SMNP-enabled COTS device receives a request, known as an SNMP request, for the information pertaining to an SNMP variable, the COTS device accesses the data (stored in that device) corresponding to the SNMP variable. The COTS device then transmits a response, known as an SNMP response, to the requester. The response content contains the information corresponding to the requested status/statistic, based on the accessed data. Further, the VPN router 170, in addition to the COTS devices, also serves as an SNMP-enabled device. VPN router 170 is thus adapted to maintain its own status/statistics information in accordance with the SNMP protocol, and to receive SNMP requests and to transmit SNMP responses to the requests. SNMP requests are processed using CPU 171.

SNMP variables are arranged according to a hierarchy, in what is known as a Management Information Base (MIB). The MIB organizes the SNMP variables into categories and sub-categories according to the type of statuses/statistics, in a conceptually-based tree structure. Each SNMP variable is made up of several fields. First, each variable is associated with an object identifier (OID). The OID is made up of a sequence of numbers (e.g., 1.3.6.1.4.1.20542.1.1), where each successive number is associated with a successive branch level of the MIB tree corresponding to the COTS device. An SNMP variable also includes a name field, which describes the variable. Finally, the SNMP variable includes a data, which stores the accumulated status/statistic data corresponding to the SNMP variable.

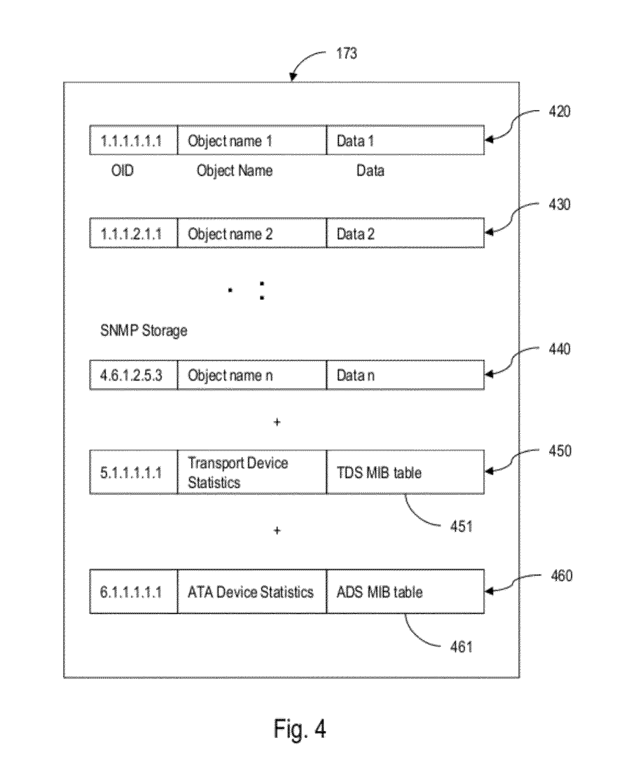

SNMP storage 173 of VPN router 170 will now be described, with reference to FIG. 4. SNMP storage maintains storage of SNMP variables. SNMP storage 173 stores SNMP variables 420, 430, 440, and 450, in this example. In FIG. 4, SNMP storage 173 is shown as storing the SNMP variables 420, 430, 440, and 450 in a table format, but it will be appreciated that the SNMP variables could be stored as any data structure format which provides access to the stored information. In FIG. 4, SNMP variables 420, 430, and 440 are standard SNMP variables which are associated with the standard features of VPN router 170. According to an exemplary embodiment, VPN router 170 has been specially configured to also include additional SNMP variables 450 and 460. That is, VPN router 170 is modified to enhance SNMP storage 173 to include SNMP variables 450 and 460. For the purpose of explaining this embodiment, SNMP variable 450 will be referred to as Transport Device Statistics, while SNMP variable 460 will be referred to as ATA Device Statistics. SNMP variable 450 also defines and stores a new MIB table 451, referred to herein as a Transport Device Statistics (TDS) MIB table. Each entry in the TDS MIB table includes a field for TDS name, TDS OID and TDS Value. Similarly, SNMP variable 460 defines and stores a new MIB table 461, referred to herein as an ATA Device Statistics (ADS) MIB table. Each entry in the ADS MIB table includes a field for ADS name, ADS OID and ADS Value. In essence, the SNMP storage 173 on the VPN router 170 is enhanced to include a MIB table for each class of COTS devices that are connected to the VPN router 170.

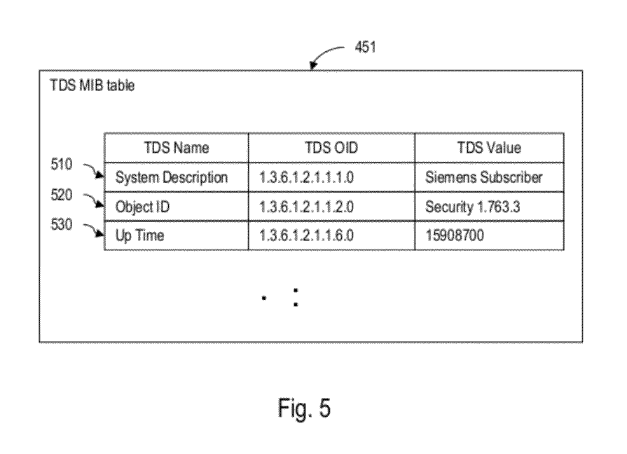

FIG. 5 depicts TDS MIB table 451 in greater detail. TDS MIB table 451, for example, contains three entries 510, 520, and 530. As described in further detail below, however, depending on the number of SNMP variables selected as an initial configuration, TDS MIB table 451 may contain any number of entries. The entries in TDS MIB table 451 maintain the status/statistics data which has been collected for the particular SNMP variables selected for monitoring for a COTS transport device. Specifically, the TDS name field is a description of an SNMP variable which has been selected for monitoring using VPN router 170. The TDS OID field is an OID for the SNMP variable which has been selected for monitoring, which corresponds to the TDS name. Finally, the TDS Value field contains the received status/statistics data corresponding to the SNMP variable, and corresponding to the TDS name and TDS OID of the entry. ADS MIB table 461 is identical in structure to TDS MIB table 451, except that the fields are defined in terms of ADS fields. That is, the TDS OID, TDS name, and TDS value fields are replaced with ADS OID, ADS name, and ADS value fields corresponding to SNMP variables for COTS application devices.

The construction of a CPE device with respect to remote site 140 is similar to that of remote site 120. That is, VPN router 180 serves as a CPE device. However, instead of DSL modem 122, wireless modem 142 is used to connect to NAP network 106. The remaining features at remote site 140 correspond to the equivalent features at remote site 120. Further, as described above, any device connected to a CPE device, regardless of whether it is connected on the LAN side or the WAN side, is referred to herein as a COTS device. According to one exemplary embodiment, as also described above, the devices connected to LANs 123 and 143, and the modems 122 and 142, are all COTS devices. That is, a COTS device as referred to herein includes all classes of such devices, such as, for example, classes of modems, classes of ATAs, etc.

NOC Monitoring Apparatus

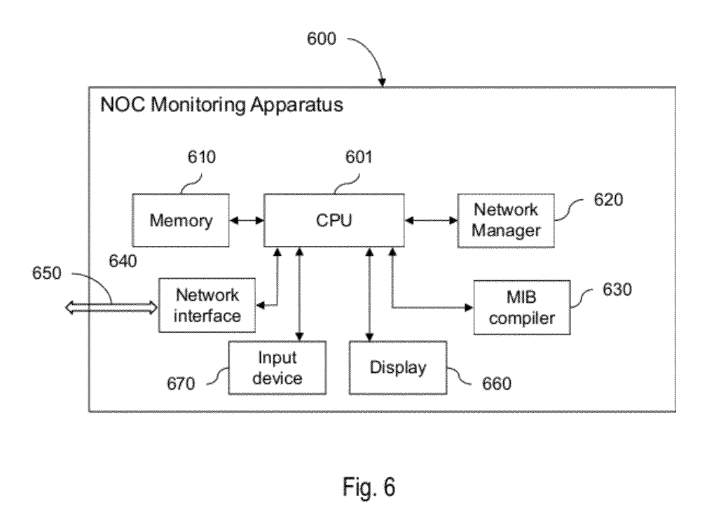

FIG. 6 depicts a block diagram of the features of a NOC monitoring apparatus 600. NOC monitoring apparatus 600 includes a CPU 601, a memory 610, and a network interface 640. Network interface 640 receives and transmits data to other network-connected devices, such as data to be received by a CPE device such as VPN router 170 or VPN router 180. NOC monitoring apparatus 600 also includes a network manager module 620 (hereinafter referred to as “Network Manager”) and a MIB compiler module 630. Network Manager 620 is used to perform the initial configuration of a CPE device, and/or to request SNMP monitoring data from the CPE device. MIB compiler module 630 is used to compile the MIB of a COTS device. The functions of these modules will be described further below. Unless stated otherwise, all modules are software components which are stored in the memory and executed by CPUs of the respective devices. It will be appreciated, however, that the modules could alternatively be constructed as hardware components or a combination of hardware and software components. NOC monitoring apparatus 600 further includes a display 660 for displaying information to a user, and an input device 670 for a user to input information. Display 660 may include, for instance, a CRT or LCD monitor, but is not limited to such. Input device 670 may include a keyboard and/or a mouse, but is not limited to such.

Initial Configuration of CPE Device

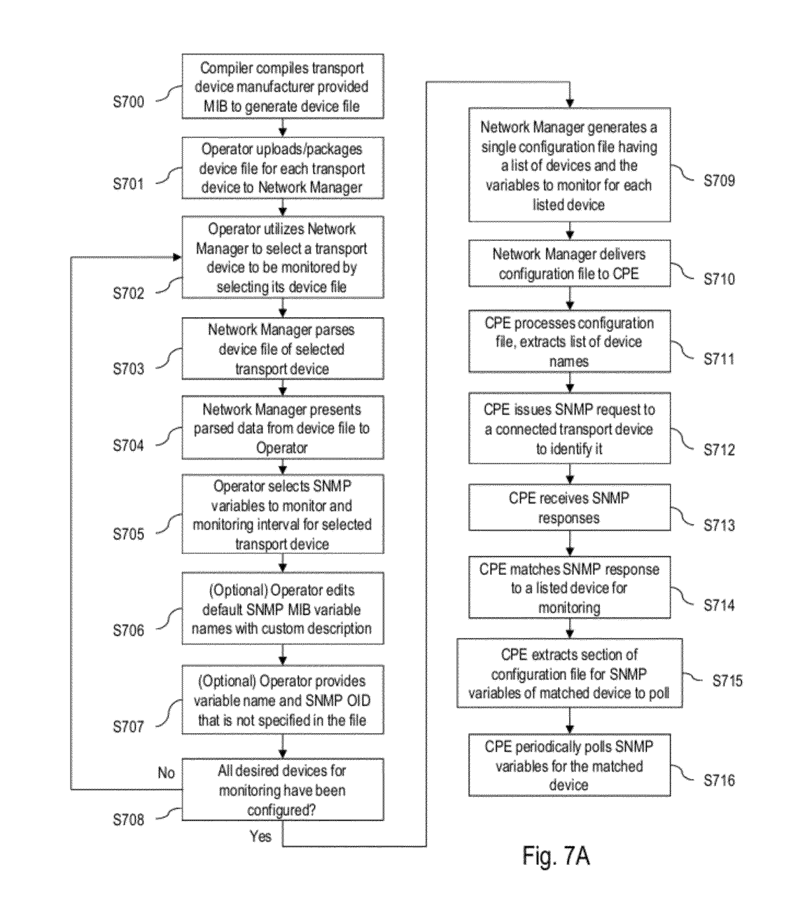

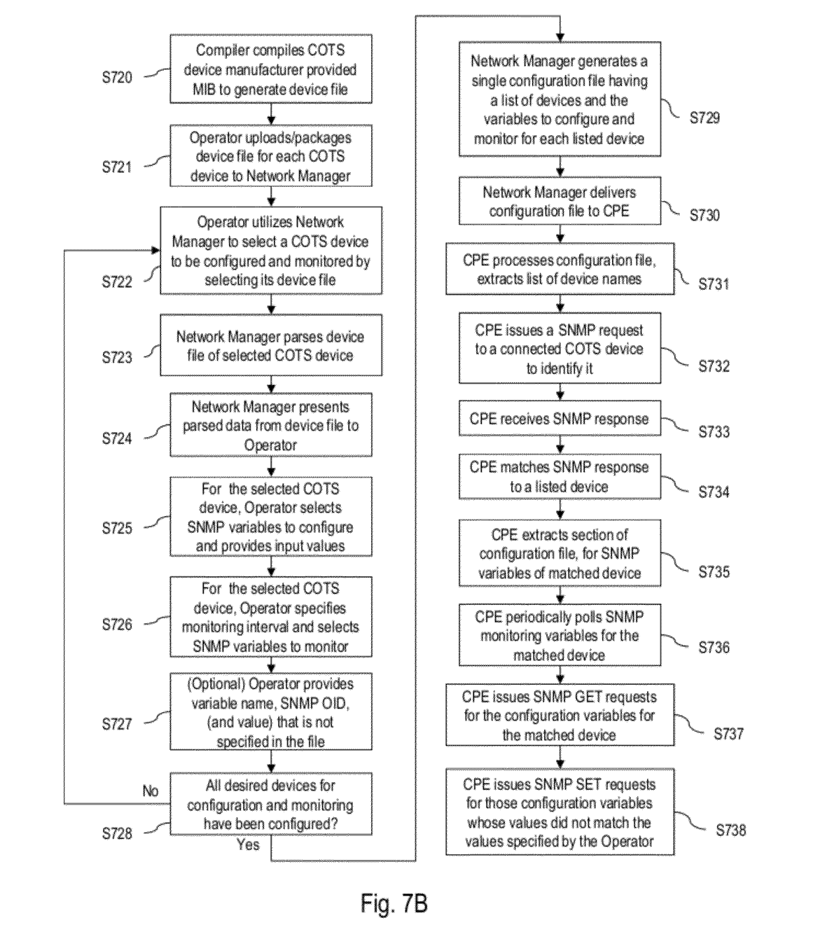

FIG. 7A depicts a flow chart illustrating the steps for the NOC monitoring apparatus 600 to initialize a CPE device to monitor the selected class of COTS transport devices, in accordance with an exemplary embodiment. First, in step S700, MIB compiler module 630, upon instruction from a compiler operator, receives a transport device MIB from the operator, and compiles the MIB. The operator typically obtains the MIB from the manufacturer of the transport device. The compilation process generates a device file that contains SNMP MIB variable names and corresponding SNMP OIDs for the transport device. The compilation may be done using any applicable MIB compiler, such as MOSY and post-MOSY. In step S700, MIB compiler module 630, upon instruction from the compiler operator, repeats the compilation process for each of the supported transport devices in the managed network by receiving the device's MIB from the operator and compiling the MIB. At the end of step S700, MIB compiler module 630 has generated a device file for each of the supported transport devices in the entire managed network (VPN). MIB compiler module 630 provides these files to the operator.

In step S701, the operator delivers the device files to the Network Manager 620. Typically, the operator of Network Manager 620 is the same operator as that of MIB compiler module 630; however, it will be appreciated that different operators could operate MIB compiler module 630 and Network Manager 620. In the embodiment, the operator delivers the device files by either uploading the device file for each transport device to Network Manager 620, or by packaging the device files with network management software at the NOC for delivery to Network Manager 620. It will be understood, however, that any alternative delivery method could be used, as long as Network Manager 620 receives the device files.

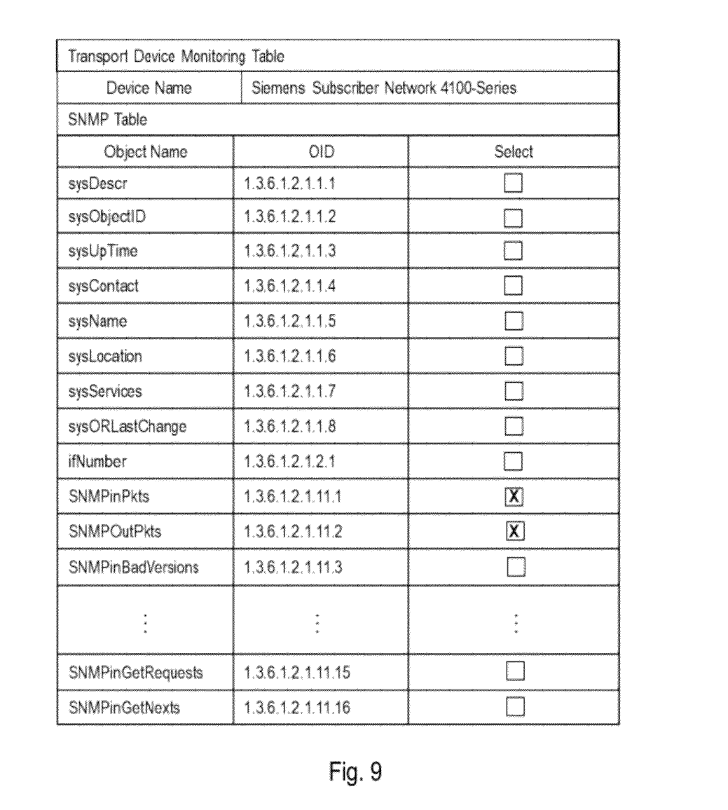

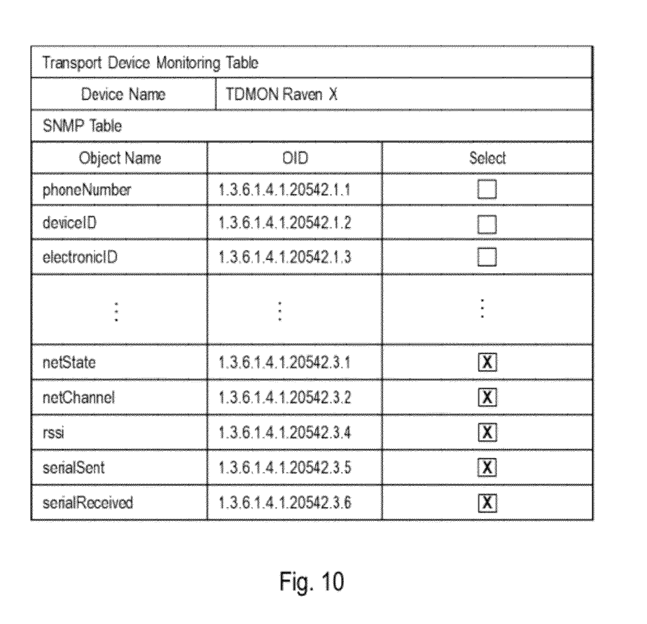

In step S702, the operator of Network Manager 620, using a user interface of Network Manager 620, selects a transport device to be monitored. The operator may accomplish this by browsing through the available device files using display 660 and selecting the device file for the transport device using input device 670. Once an operator selects a transport device, Network Manager 620 adds the device to a table of devices to monitor. In step S703, once the operator selects a transport device, Network Manager 620 parses the device file of the selected transport device, to extract the SNMP variables that are available for monitoring, according to the transport device's manufacturer provided MIB that was compiled in step S701 and was delivered to Network Manager 620 in step S701. In step S704, Network Manager 620 presents the parsed data to the operator, using display 660. This may take the form of a graphical checklist of SNMP variables that can be monitored for the selected transport device, as depicted in FIGS. 9 and 10. For instance, in FIG. 9, the selected device file is “Siemens Subscriber Network 4100-Series_mib.dat” (only the trailing end of filename is visible in FIG. 9). This device file corresponds to a transport device name of “Siemens Subscriber Network 4100-Series” (only the trailing end of device name is visible in FIG. 9). The displayed list of SNMP variables includes, for instance, “sysDescr,” which corresponds to an OID of 1.3.6.1.2.1.1.1. In FIG. 10, the selected device file is “raven x_mib.dat,” which corresponds with a device name of “Raven X.” The displayed list of SNMP variables includes, for instance, “phoneNumber,” which corresponds to an OID of 1.3.6.1.4.1.20542.1.1.

In step S705, the operator selects, using input device 670, the SNMP variables among the displayed SNMP variables, which are desired for monitoring. This may be accomplished using checkboxes alongside a graphical checklist of SNMP variables shown on display 660, as depicted in FIGS. 9 and 10. In this way, the operator can select (e.g., by using a graphical user interface) one or more SNMP variables of a transport device to be monitored out of all the SNMP variables for the given transport device. Typically, the operator will select a subset, i.e., less than all available SNMP variables. The operator also enters, using input device 670, the interval at which SNMP polling of the selected transport device should be performed, along with a time-out interval for conducting the SNMP polling. This may be accomplished, for example, using a text input box shown on display 660, as seen in FIGS. 9 and 10. In FIG. 9, the operator has selected text input boxes corresponding to the SNMP variables of “snmpInPkts” and “snmpOutPkts,” with the text input boxes at the right column of the SNMP table list. In FIG. 10, the operator has selected text input boxes corresponding to the SNMP variables of “netState,” “netChannel,” “rssi,” “serialSent,” and “serialReceived.”

In step S706, the operator may optionally edit, using input device 670, the default SNMP MIB variable names in the graphical checklist displayed by Network Manager 620 on display 660. This feature allows the operator to provide a more descriptive or intuitive name for the variable. For instance, in FIG. 9, the operator may edit the SNMP variable name of “snmpInPkts” to “Number Of Inbound Packets.” In step S707, the operator may also optionally add, using input device 670, an SNMP variable name and OID which was not included in the device file for the selected transport device. For instance, if the compiler in step S700 failed to include a particular SNMP variable that is part of the SNMP MIB tree for the transport device, the operator has an opportunity to manually add that SNMP variable at this point, to the list of SNMP variables.

In step S708, the operator determines if all transport devices which are desired to be configured for monitoring have already been configured. If not, the operator can configure Network Manager 620 to add configuration for another transport device, returning to step S702. It should be noted that although the present embodiment adds transport devices one at a time to the list of transport devices to monitor, and uses a checklist interface for selecting SNMP variables for a transport device, any other interface for adding transport devices and/or selecting the desired SNMP variables may be used in connection with Network Manager 620. In step S708, if the operator has finished configuring all desired transport devices for monitoring, then the process moves to step S709. Otherwise, the process moves back to step S702 to select another device file for a transport device.

In step S709, Network Manager 620 generates a configuration file, which includes a list of the transport devices selected by the operator for monitoring, along with all of the SNMP variables selected by the operator for monitoring for each listed transport device. In other words, the configuration file includes both (a) a list of one or more transport devices, and (b) for each transport device, a list of one or more SNMP variables. Note that the list of transport devices may include both transport devices actually deployed in a network and other transport devices not yet deployed, so that if a user adds one of the latter devices to a network, the CPE device will be able to monitor one or more previously-selected SNMP variables for the newly-added device. Note that the transport device name in the configuration file is auto-generated by the Network Manager based on the device file name preceding “_mib.dat.” In one embodiment, the configuration file is a single configuration file that contains all of the described information. However, it will be understood that the information could alternatively be stored in multiple configuration files. In certain embodiments, such multiple files (or other data structures known to those of skill in the art used as alternatives to a file) holding the described information shall be referred to as a “configuration file.”

In summary, according to an exemplary embodiment, the single generated configuration file specifies the configuration of all the transport devices supported in system 100 (i.e., the class of COTS transport devices supported in system 100).

In step S710, Network Manager 620 delivers the configuration file to the CPE device. For the purposes of this description, the following steps will be explained with respect to VPN router 170 as the CPE device. It will be appreciated, however, that the steps are applicable to VPN router 180 or any other CPE device. In the present embodiment, the configuration file is transferred according a network configuration update mechanism, by using FTP or a script. However, any other method of data transfer may be used, as long as VPN router 170 receives the configuration file. Additionally, it will be understood that the configuration data is not necessarily stored or transmitted as a file, but can alternatively be stored and/or transmitted as any data format, as long as VPN router 170 receives the above-described contents of the configuration file.

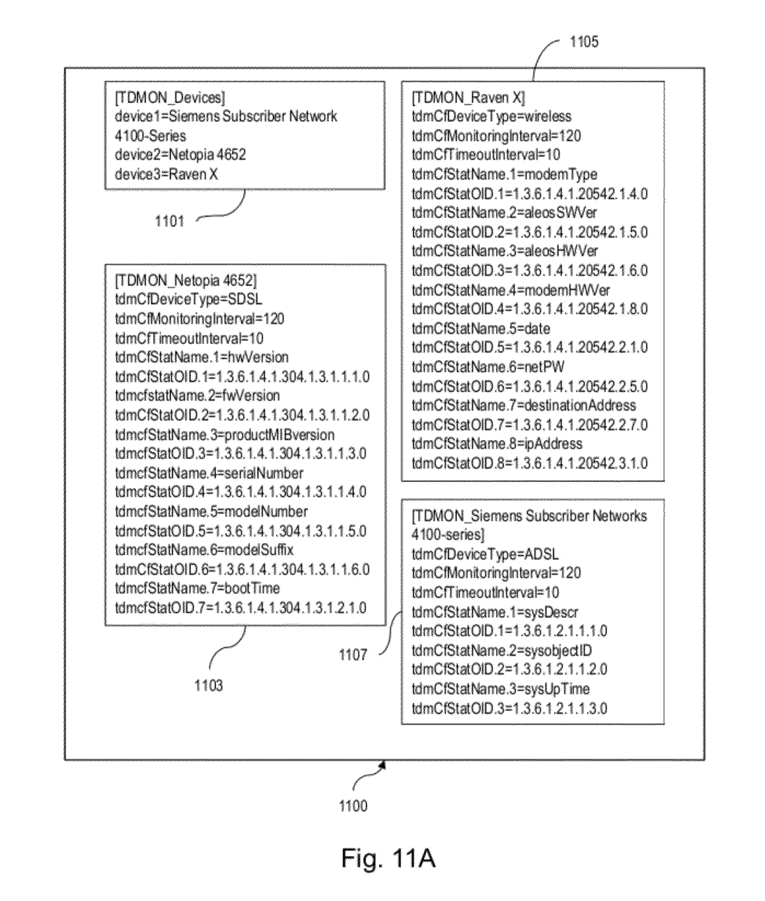

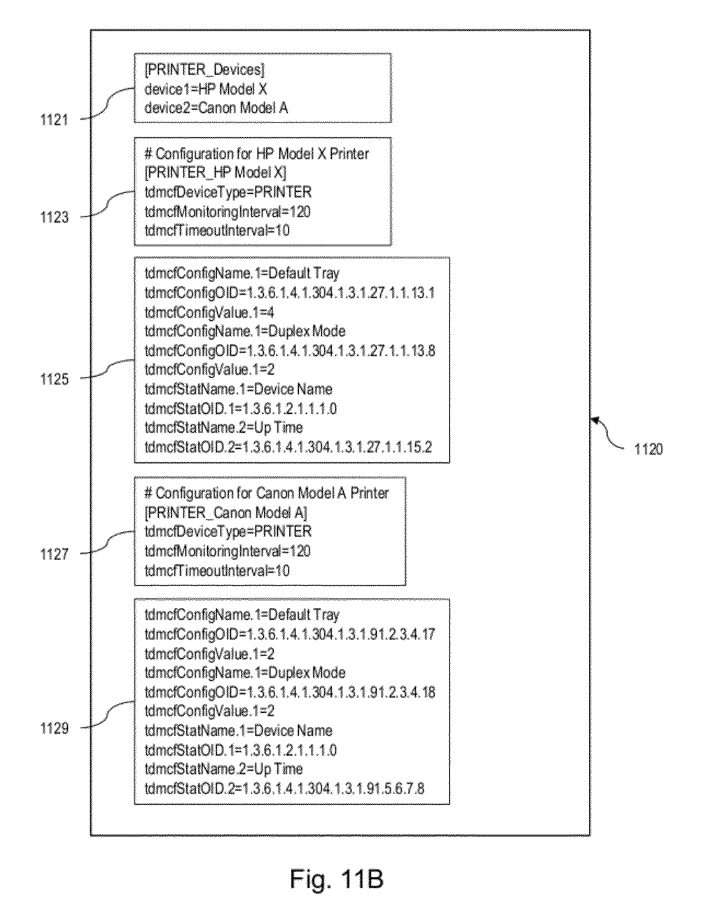

FIG. 11A depicts a sample configuration file 1100 generated in accordance with steps S709 and S710. As seen in FIG. 11A, the configuration file contains an initial section 1101 listing the transport devices for monitoring. Then, for each of such transport device, a list of SNMP variables and OIDs are included, along with a monitoring interval and a timeout interval—1103, 1105 and 1107, respectively. A device type may also be listed. Initially, in FIG. 11A, the first section lists the transport devices to be monitored. Three devices are listed in this example: “Siemens Subscriber Network 4100-Series,” “Netopia 4652,” and “Raven X.” For each of the transport devices listed in the first section, the configuration file contains an additional section listing the SNMP variables and OIDs to monitor for that device. For instance, a section is titled “TDMON_Netopia 4652” to correspond to the Netopia 4652 transport device. Within that section, seven SNMP variables are listed, starting with “hwVersion” (OID of 1.3.6.1.4.1.304.1.3.1.1.1.0), and ending with “bootTime” (OID of 1.3.6.1.4.1.304.1.3.1.2.1.0). The section also includes other information, such as the monitoring and timeout intervals from step S705, and a device type. Likewise, sections of “TDMON_Raven X” and “TDMON_Siemens Subscriber Network 4100-series” list the SNMP variables to be monitored and the other information, for those respective transport devices. The configuration file depicted is an INI file. However, it will be appreciated that the configuration file is not limited to such a format, and that any configuration file format can be used, as long as the information is recognized by VPN router 170.

In step S711, VPN router 170, upon receiving the configuration file, processes the configuration file. The initial processing includes extracting the list of transport devices in the configuration file. In step S712, VPN router 170 issues SNMP requests to all transport devices attached to WAN interface 174. In this embodiment, the SNMP request preferably requests the MIB-II sysDescr variable. Any other SNMP variable (e.g., sysObjectID), however, can be requested, which can be used to identify the transport device. In step S713, VPN router 170 receives SNMP responses from the transport devices, which are SNMP enabled, attached via WAN interface 174. In step S714, VPN router 170 processes the SNMP responses, to examine whether a substring match exists between the device name provided in the SNMP response and any of the listings of transport devices extracted from the configuration file generated in step S711. That is, a match is found when the listing name of a transport device extracted from the configuration file is a substring of the device name in the SNMP response. A substring match includes both exact and partial matches. For example, the list of transport devices in the configuration file may include entries for “Siemens Subscriber Network 4100-Series” and “Raven X,” as shown in FIG. 11A. If the substring “Siemens Subscriber Network 4100-Series” is found in the SNMP response from a transport device, the device is identified as a Siemens 4100 DSL modem. Similarly, if the substring “Raven X” is found in the SNMP response from a transport device, the device is identified as a Raven-X wireless modem.

In step S715, if a match is found, then VPN router 170 parses the section of the configuration file which relates to the particular identified transport device, and extracts the variables identified for SNMP polling. For example, if the device identified is a Raven-X modem, the [TDMON_Raven X] section, as depicted in the configuration file of FIG. 11A, is extracted from the configuration file. In step S716, once the transport device is identified for monitoring, and the respective SNMP variables for polling and the polling interval are established, the VPN router 170 periodically polls the monitored transport device at the specified monitoring interval for the identified SNMP polling variables. VPN router 170 stores the status/statistics information received as a result of the polling in the TDS MIB table 451 within SNMP storage 173. Further, in the case of multiple transport devices, the status/statistics information received as a result of the polling will be stored in multiple such MIB tables or a single table of tables.

The VPN router 170 also periodically checks for updates in the transport devices connected to it. Thus, if a transport device for monitoring is initially not connected to VPN router 170, but later becomes connected to it, VPN router 170 determines that the transport device is present and should be monitored for the specified SNMP variables.

The configuration for monitoring COTS application devices is accomplished using the same steps. That is, instead of steps S700-S716 being applied to transport devices, system 100 performs the steps as applied to COTS application devices such as, e.g., ATAs. The differences in steps S700-S716 for the configuration of monitoring COTS application devices will be described. In steps S700-S708, all operations as related to transport devices are instead applied to application devices. That is, MIBs and device files for application devices are incorporated.

The configuration file will contain, instead of configurations for transport devices, configurations for COTS application devices such as, e.g., ATAs. It is noted that, in one embodiment, a single configuration file storing information for both transport devices and application devices may be used. Alternatively, separate configuration files may be generated. In step S712, VPN router 170 issues SNMP requests to all application devices on LAN 123, preferably by requesting the MIB-II sysDescr variable to identify the COTS device. Since the VPN Router 170 typically assigns the IP addresses on LAN 123, it uses the assigned IP address for the SNMP query. In step S713, VPN router 170 receives SNMP responses from the application devices, which are SNMP enabled, attached via LAN interface 176, and in step S714, identifies the application devices. In step S716, instead of TDS MIB table 451, VPN router 170 stores the SNMP status/statistics information relating to COTS application devices in their respective MIB tables, for example, the ATA device information in the ADS MIB table 461.

COTS Device Auto-Configuration

For the COTS devices on the local LAN, the VPN Router 170 assigns IP addresses via DHCP. The VPN Router 170 then uses the assigned IP address to query the device for the MIB-II sysDescr variable. The VPN Router 170 then checks the list of supported devices under each class of devices (e.g., Transport Devices, ATA Devices, Printers, etc.) to identify the device based on the SNMP sysDescr variable response. Accordingly, for a known supported device, the VPN Router 170 starts polling the Operator-specified SNMP variables for that particular device. According to a further exemplary embodiment, based on the foregoing device auto-detection and monitoring processes, the VPN Router may also configure the COTS device. Each COTS device on the managed network (e.g., the LAN) requests an IP address at power up. The VPN Router 170 then discovers the identity of the respective COTS device, provides associated configuration data to the COTS device, and then monitors it periodically. Accordingly, new devices can be added to the local LAN without any requirement for an installer. For each device, the operator specifies two lists—a list of SNMP configuration variables and a list of SNMP monitoring (status/statistics) variables. FIG. 7B depicts a flow chart illustrating a detection, identification, monitoring and configuration process for COTS devices on the LAN side, and FIG. 11B illustrates a sample configuration file for managing two printer models in a customer network, in accordance with exemplary embodiments.

Referring to FIG. 7B, the steps S720 to S724 and S726 to S736 follow the same process as the steps 700 to 716 of FIG. 7A, respectively. The process of FIG. 7B, as a further example, however, addresses COTS devices instead of the transport devices (as in FIG. 7A). While the process of FIG. 7B addresses COTS devices, it will be appreciated that the process may similarly be implemented to handle the transport devices on the LAN. In step S710, Network Manager 620 delivers the configuration file to the CPE device. In addition to the steps S720 to S736, the auto-configuration features of this embodiment include steps S725, S737 and S738. Pursuant to step S725, the operator selects the SNMP variables to configure and specifies the values for those variables. Pursuant to step S737, the CPE issues SNMP get requests to obtain the configuration variables for the matched device. Then, pursuant to S738, the CPE issues SNMP SET requests for those configuration variables whose values did not match the values specified by the Operator, for configuration of the device. Unlike monitoring, which involves periodic polling, configuration of the COTS device is performed typically at start up when an IP address is assigned or when the operator performs configuration updates from the NOC—that is, when the value(s) for the SNMP configuration parameter(s) change. As will be appreciated, according to this monitoring and configuration embodiment, the Network Manager generates a single configuration file listing the devices being monitored and configured, where the single file contains both the variables for configuration and for monitoring, for each listed device.

FIG. 11B depicts a sample configuration file 1120 generated in accordance with steps S729 and S730. As seen in FIG. 11B, the configuration file contains an initial section 1121 listing the COTS devices for monitoring and configuration. In this example, the devices are the HP Model X and the Canon Model A printers. Then, for each such COTS device, the file includes a section listing the SNMP device type, along with a monitoring interval and a timeout interval, for the variables being monitored—1123 and 1127, respectively. For each of the listed COTS devices, the configuration file also includes a section listing the SNMP variables, OIDs and value for configuration, along with the SNMP variables and OIDs to monitor, for that device—1125 and 1129, respectively. The configuration file 1120 depicted is an INI file. It will be appreciated, however, that the configuration file 1120 is not limited to such a format, and that any configuration file format can be used, as long as the information is recognized by VPN router 170. Further, according to the configuration file 1120 of FIG. 11B, for example, a retail chain uses two types of printers in its stores. As long as the printer connected to the VPN Router 170 is either HP Model X or Canon Model A, the VPN Router 170 will recognize the device, configure it (e.g., with the Default Tray and Duplex Mode variables, as depicted in FIG. 11B), and monitor it (e.g., for the Up Time). Accordingly, the system and method according to exemplary embodiments provides for automatic configuration of the COTS device after the device identification. In other words, a complete plug-and-play management of the COTS device is provided, whereby the VPN Router 170 detects a COTS device and assigns an IP address to the COTS device, as well as automatically identifying, configuring and monitoring the COTS device. Further, the COTS devices can be added or replaced on the VPN Router 170's LAN with plug-and-play management style as long as the COTS device is recognized by the VPN Router 170 as a supported device type.

Retrieving SNMP Data

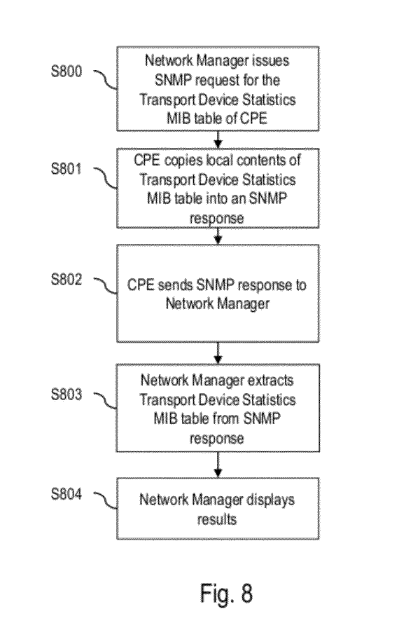

FIG. 8 depicts a flow chart illustrating the steps for NOC monitoring apparatus 600 to retrieve SNMP status and/or statistics data from a CPE device. For the purposes of this description, the following steps will be explained with respect to VPN router 170 as the CPE device. It will be appreciated, however, that the steps are applicable to VPN router 180 or any other CPE device.

Initially, in step S800, upon a request by NOC monitoring apparatus 600 for the status/statistics data of VPN router 170, Network Manager 620 issues an SNMP request to VPN router 170. This SNMP request is configured to request the contents of TDS MIB table 451, stored within SNMP storage 173 of VPN router 170. As previously mentioned, TDS MIB table 451 within SNMP storage 173 contains the collected monitoring data from periodically polling SNMP variables in step S716, for the SNMP variables to be monitored for the transport devices identified to be polled. In step S801, upon receiving the SNMP request, VPN router 170 copies the local contents of TDS MIB table 451 into an SNMP response. VPN router 170 can package the contents of the table according to any data arrangement in the SNMP response, so long as Network Manager 620 is able to successfully extract the contents of the TDS MIB table from the SNMP response. In Step S802, VPN router 170 sends the SNMP response to Network Manager 620. In step S803, Network Manager 620, upon receiving SNMP response, extracts the TDS MIB table copied into the SNMP response from VPN router 170.

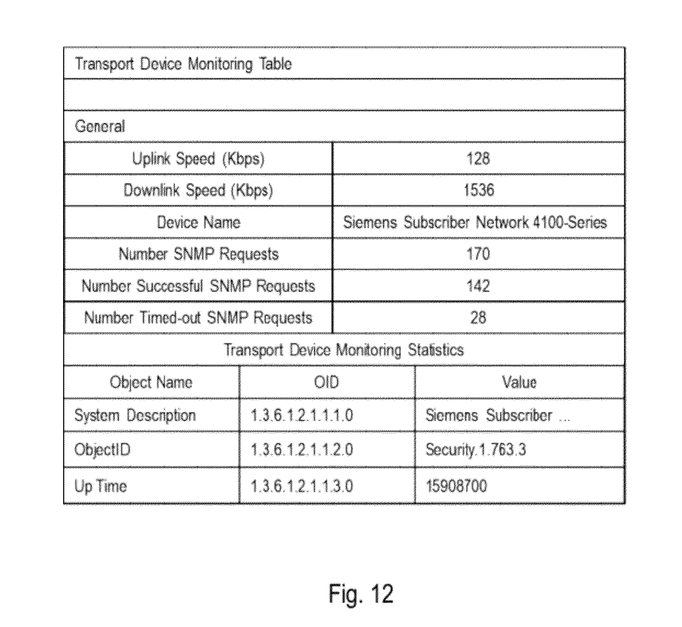

In step S804, Network Manager 620 displays the results of the extracted TDS MIB table to the requester of the status/statistics, using display 660. In this embodiment, this display is formatted as a table, with each entry displaying the name, OID, and the value for each status/statistic, as depicted in FIG. 12. As seen in the display of FIG. 12, it is made clear to the operator that the VPN Router 170 is actually connected to a Siemens Subscriber Network 4100-Series modem 122 at the remote site 120. It will be appreciated that this information is not known a priori and is provided by the VPN Router 170 based on its auto-detection and identification of the modem device. Furthermore, only the SNMP variables which are of interest to the operator, by being previously selected in the initial configuration of FIG. 7, are listed in the displayed table. In accordance with FIGS. 11A and 12, the Siemens Subscriber Network 4100-Series DSL modem was previously configured for monitoring by VPN router 170, using the INI configuration file in FIG. 11A. As seen in FIG. 11A, the configuration file lists the SNMP variables of “System Description,” “Object ID,” and “Up Time” for monitoring by VPN router 170. As depicted in FIG. 12, only those three SNMP variables are displayed, along with their respective values. Remaining SNMP variables which are capable of being monitored in the Siemens Subscriber Network 4100-Series DSL modem are not monitored, and are not provided on display 660.

It will be further appreciated that the NOC may contain a plurality of NOC monitoring apparatuses, and it is not necessary that the NOC monitoring apparatus used to initially configure a CPE device be the same NOC monitoring apparatus used to retrieve the SNMP data. That is, different operators, using different NOC monitoring apparatuses, may perform the functions of initializing the CPE device and retrieving the monitoring data.

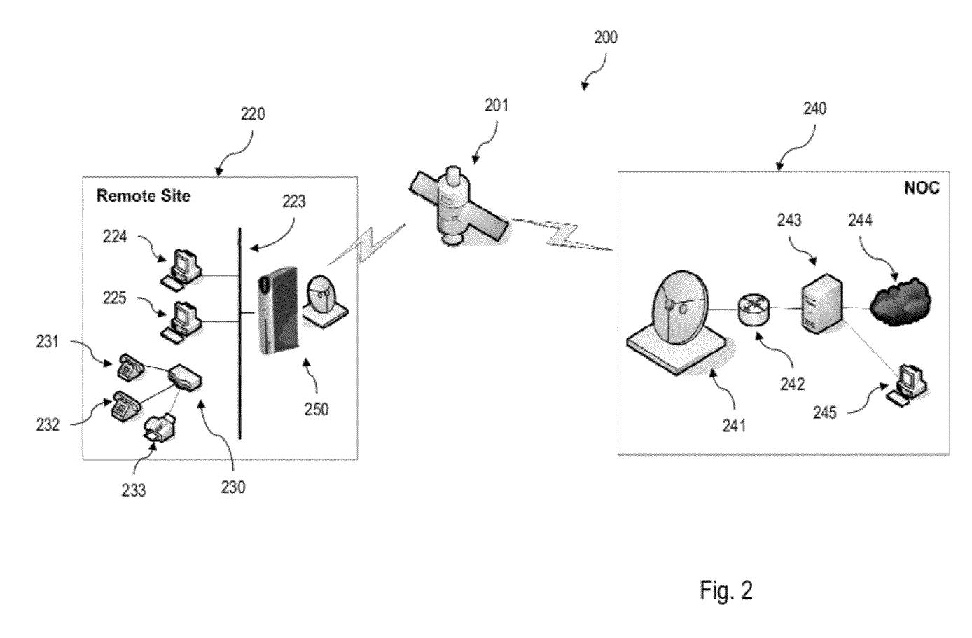

FIG. 2 illustrates a satellite system 200, in accordance with a further exemplary embodiment. System 200 includes a NOC 240 and at least one remote site 220. In the example of FIG. 2, there is a single remote site. However, it will be appreciated that system 200 may be configured with multiple remote sites. NOC 240 includes a NOC antenna 241, a router 242, a gateway 243, an enterprise network 244, and a monitoring apparatus 245. NOC antenna 241 sends data to, and receives data from, a satellite 201. NOC antenna 241 is connected to router 242. Router 242, in a receive direction, demodulates a received signal, packetizes the data as IP packets, and sends the IP packets to gateway 243. In the transmit direction, router 242 receives IP packets from the gateway 243, converts them into satellite transmit bursts, and modulates the signal to be transmitted via NOC antenna 241 to satellite 201. Gateway 243, in turn, provides VPN access to enterprise network 244. Monitoring apparatus 245 is connected to gateway 243 via a management interface, and configures remote CPE devices for monitoring, and also polls the remote CPE devices for SNMP status/statistics information, as will be later described.

Remote site 220 includes a VSAT 250 having router functionality, and a LAN 223. LAN 223 interconnects VSAT 250 with various devices, such as computers 224, 225 and an ATA 230. ATA 230 allows connectivity of phone-related components, such as telephones 231 and 232, a fax machine 233, or any other components which connect over a phone line. Remote site 220 communicates with NOC 240 over satellite 201, which provides data connectivity between VSAT 250 and NOC 240. VSAT 250 in the second embodiment performs SNMP monitoring in an analogous manner to VPN router 170 in the first embodiment, with the following exceptions. In system 200, VSAT 250 may perform monitoring of status/statistics information for COTS application devices connected to LAN 223, such as the network performance of ATA 230. That is, in system 200, VSAT 250 may be the CPE device.

According to the present embodiment, the construction of a CPE device with respect to remote site 220 is similar to that of remote site 120, with the exception of the following differences. Instead of VPN router 170, remote site 220 contains VSAT 250, which serves as a CPE device. The construction of VSAT 250 is similar to that of VPN router 170, except that instead of WAN interface 330 connected to DSL modem 122, VSAT 250 is integrated with a satellite transceiver. Therefore, VSAT 250 is primarily interested in monitoring COTS devices connected on the LAN side (i.e., connected to LAN 223). For instance, VSAT 250 may be interested in the SNMP status/statistics information for ATA 230, to determine call performance of telephones 231 and 232. In monitoring devices on LAN 223, VSAT 250 uses corresponding components and operations as used by VPN router 170 to monitor devices on LAN 123. Additionally, the remaining features at remote site 220 correspond to the equivalent features at remote site 120.

Accordingly, NOC monitoring apparatus 245 is similar to NOC monitoring apparatus 600 in the first embodiment, in that NOC monitoring apparatus 245 follows the steps of FIG. 7 to configure SNMP variables to monitor for selected application devices (e.g., ATA devices), and delivers a configuration file to VSAT 250. VSAT 250 then identifies devices (e.g., ATA 230) on LAN 223 as application devices to be monitored, and periodically polls the application devices for SNMP status/statistics data. NOC monitoring apparatus 245 also follows the steps of FIG. 8 to request SNMP data from VSAT 250. That is, NOC monitoring apparatus 245 sends an SNMP request to VSAT 250, which responds with a copy of its ADS MIB table. NOC monitoring apparatus 245 then displays, to an operator, only the SNMP variables that were previously selected to be monitored, for the application devices that were previously selected and are connected to VSAT 250.

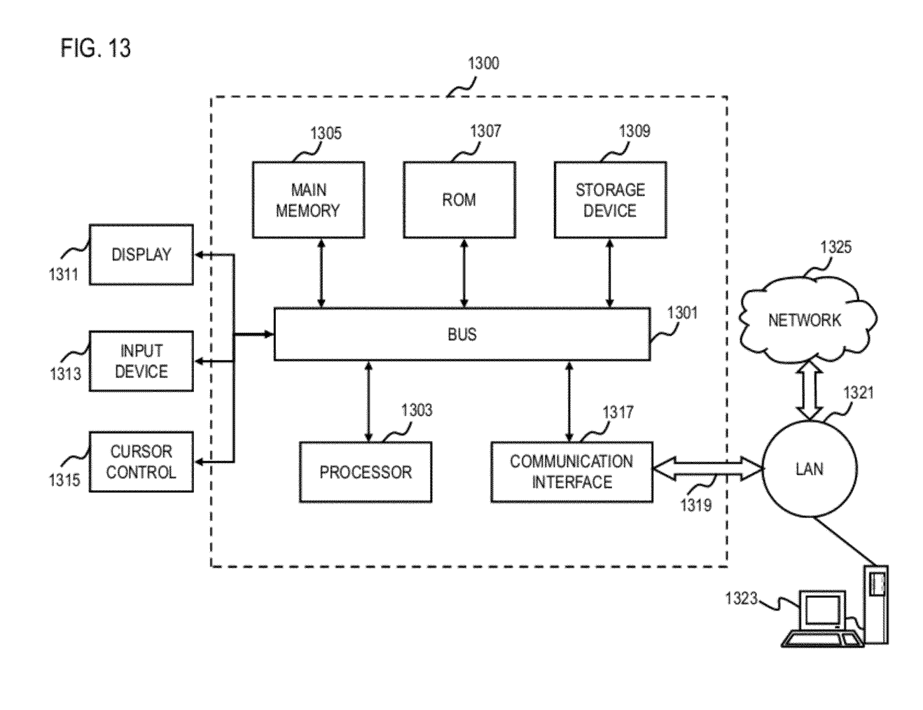

FIG. 13 illustrates a computer system upon which exemplary embodiments according to the present invention can be implemented. The computer system 1300 includes a bus 1301 or other communication mechanism for communicating information, and a processor 1303 coupled to the bus 1301 for processing information. The computer system 1300 also includes main memory 1305, such as a random access memory (RAM) or other dynamic storage device, coupled to the bus 1301 for storing information and instructions to be executed by the processor 1303. Main memory 1305 can also be used for storing temporary variables or other intermediate information during execution of instructions to be executed by the processor 1303. The computer system 1300 further includes a read only memory (ROM) 1307 or other static storage device coupled to the bus 1301 for storing static information and instructions for the processor 1303. A storage device 1309, such as a magnetic disk or optical disk, is additionally coupled to the bus 1301 for storing information and instructions.

The computer system 1300 may be coupled via the bus 1301 to a display 1311, such as a cathode ray tube (CRT), liquid crystal display, active matrix display, or plasma display, for displaying information to a computer user. An input device 1313, such as a keyboard including alphanumeric and other keys, is coupled to the bus 1301 for communicating information and command selections to the processor 1303. Another type of user input device is cursor control 1315, such as a mouse, a trackball, or cursor direction keys for communicating direction information and command selections to the processor 1303 and for controlling cursor movement on the display 1311.

Approaches for managing customer premise devices within a managed network, in accordance with exemplary embodiments, may be provided by the computer system 1300 in response to the processor 1303 executing an arrangement of instructions contained in main memory 1305. Such instructions can be read into main memory 1305 from another computer-readable medium, such as the storage device 1309. Execution of the arrangement of instructions contained in main memory 1305 causes the processor 1303 to perform the process steps described herein. One or more processors in a multi-processing arrangement may also be employed to execute the instructions contained in main memory 1305. In alternative embodiments, hard-wired circuitry may be used in place of or in combination with software instructions to implement the embodiment of the present invention. Thus, embodiments of the present invention are not limited to any specific combination of hardware circuitry and software.

The computer system 1300 also includes a communication interface 1317 coupled to bus 1301. The communication interface 1317 provides a two-way data communication coupling to a network link 1319 connected to a local network 1321. For example, the communication interface 1317 may be a digital subscriber line (DSL) card or modem, an integrated services digital network (ISDN) card, a cable modem, or a telephone modem to provide a data communication connection to a corresponding type of telephone line. As another example, communication interface 1317 may be a local area network (LAN) card (e.g. for Ethernet™ or an Asynchronous Transfer Model (ATM) network) to provide a data communication connection to a compatible LAN. Wireless links can also be implemented. In any such implementation, communication interface 1317 sends and receives electrical, electromagnetic, or optical signals that carry digital data streams representing various types of information. Further, the communication interface 1317 can include peripheral interface devices, such as a Universal Serial Bus (USB) interface, a PCMCIA (Personal Computer Memory Card International Association) interface, etc.

The network link 1319 typically provides data communication through one or more networks to other data devices. For example, the network link 1319 may provide a connection through local network 1321 to a host computer 1323, which has connectivity to a network 1325 (e.g. a wide area network (WAN) or the global packet data communication network now commonly referred to as the “Internet”) or to data equipment operated by service provider. The local network 1321 and network 1325 both use electrical, electromagnetic, or optical signals to convey information and instructions. The signals through the various networks and the signals on network link 1319 and through communication interface 1317, which communicate digital data with computer system 1300, are exemplary forms of carrier waves bearing the information and instructions.

The computer system 1300 can send messages and receive data, including program code, through the network(s), network link 1319, and communication interface 1317. In the Internet example, a server (not shown) might transmit requested code belonging to an application program for implementing an embodiment of the present invention through the network 1325, local network 1321 and communication interface 1317. The processor 1303 may execute the transmitted code while being received and/or store the code in storage device 1305, or other non-volatile storage for later execution. In this manner, computer system 1300 may obtain application code in the form of a carrier wave.

The term “computer-readable medium” as used herein refers to any medium that participates in providing instructions to the processor 1303 for execution. Such a medium may take many forms, including but not limited to non-volatile media, volatile media, and transmission media. Non-volatile media include, for example, optical or magnetic disks, such as storage device 1309. Volatile media include dynamic memory, such as main memory 1305. Transmission media include coaxial cables, copper wire and fiber optics, including the wires that comprise bus 1301. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD ROM, CDRW, DVD, any other optical medium, punch cards, paper tape, optical mark sheets, any other physical medium with patterns of holes or other optically recognizable indicia, a RAM, a PROM, and EPROM, a FLASH EPROM, any other memory chip or cartridge, a carrier wave, or any other medium from which a computer can read.

Various forms of computer-readable media may be involved in providing instructions to a processor for execution. For example, the instructions for carrying out at least part of the present invention may initially be borne on a magnetic disk of a remote computer. In such a scenario, the remote computer loads the instructions into main memory and sends the instructions over a telephone line using a modem. A modem of a local computer system receives the data on the telephone line and uses an infrared transmitter to convert the data to an infrared signal and transmit the infrared signal to a portable computing device, such as a personal digital assistance (PDA) and a laptop. An infrared detector on the portable computing device receives the information and instructions borne by the infrared signal and places the data on a bus. The bus conveys the data to main memory, from which a processor retrieves and executes the instructions. The instructions received by main memory may optionally be stored on storage device either before or after execution by processor.

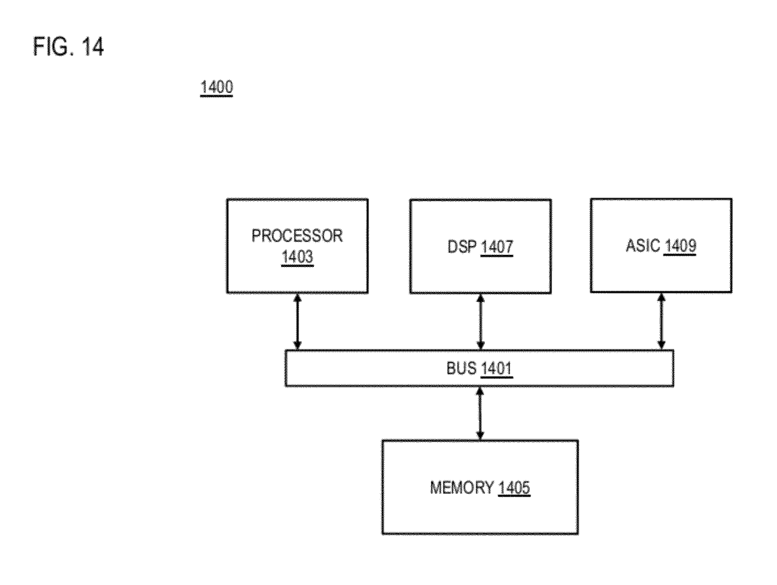

FIG. 14 illustrates a chip set 1400 in which embodiments of the invention may be implemented. Chip set 1400 includes, for instance, processor and memory components described with respect to FIG. 14 incorporated in one or more physical packages. By way of example, a physical package includes an arrangement of one or more materials, components, and/or wires on a structural assembly (e.g., a baseboard) to provide one or more characteristics such as physical strength, conservation of size, and/or limitation of electrical interaction.

In one embodiment, the chip set 1400 includes a communication mechanism such as a bus 1401 for passing information among the components of the chip set 1400. A processor 1403 has connectivity to the bus 1401 to execute instructions and process information stored in, for example, a memory 1405. The processor 1403 may include one or more processing cores with each core configured to perform independently. A multi-core processor enables multiprocessing within a single physical package. Examples of a multi-core processor include two, four, eight, or greater numbers of processing cores. Alternatively or in addition, the processor 1403 may include one or more microprocessors configured in tandem via the bus 1401 to enable independent execution of instructions, pipelining, and multithreading. The processor 1403 may also be accompanied with one or more specialized components to perform certain processing functions and tasks such as one or more digital signal processors (DSP) 1407, and/or one or more application-specific integrated circuits (ASIC) 1409. A DSP 1407 typically is configured to process real-world signals (e.g., sound) in real time independently of the processor 1403. Similarly, an ASIC 1409 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 1403 and accompanying components have connectivity to the memory 1405 via the bus 1401. The memory 1405 includes both dynamic memory (e.g., RAM) and static memory (e.g., ROM) for storing executable instructions that, when executed by the processor 1403 and/or the DSP 1407 and/or the ASIC 1409, perform the process of exemplary embodiments as described herein. The memory 1405 also stores the data associated with or generated by the execution of the process.

While the present invention is applied to a SNMP monitoring system, it not limited to such. For example, the present invention can be applied to a non-SNMP monitoring system. It will be understood that the present invention can be applied to any other type of network, communications, or integrated system which may benefit from the present invention.

While the present invention describes a preferred embodiment containing hardware and/or software, and unless stated otherwise, all functions are performed by a CPU executing computer executable programming code stored in a non-transitory memory or computer-readable storage medium, it will be understood that any of those various components can be alternatively implemented in hardware, software, or a combination thereof.

Except as otherwise disclosed herein, the various components shown in outline or in block form in the figures are individually well known and their internal construction and operation are not critical either to the making or using of this invention or to a description of the best mode of the invention.

Although specific embodiments of the present invention have been described above in detail, it will be understood that this description is merely for purposes of illustration. When it is said that something “is”, “shall”, “will”, or “should be” the case, for example, these expressions are not meant to limit the invention, but are merely providing a specific example or specific examples. Various modifications of and equivalent structures corresponding to the disclosed aspects of the preferred embodiments in addition to those described above may be made by those skilled in the art without departing from the spirit of the present invention which is defined in the following claims, the scope of which is to be accorded the broadest interpretation so as to encompass such modifications and equivalent structures.

What is claimed is:

1. A method, comprising:
identifying a network device on a managed network, wherein the network device is identified as a one of a list of one or more network device types supported by the managed network and included in one or more configuration files, and wherein the one or more configuration files further include a list of one or more respective SNMP variables to be monitored for each of the network device types;
extracting the respective listing of SNMP variables to be monitored from the one or more configuration files for the identified network device type; and
generating a request to monitor the extracted SNMP variables to be monitored for the network device.

2. A method according to claim 1, wherein the one or more configuration files further include a listing of one or more respective SNMP variables to be configured for each of the network device types listed in the configuration file, the method further comprising:
extracting the respective listing of SNMP variables to be configured from the one or more configuration files for the identified network device type; and
generating a request to configure the extracted SNMP variables to be configured for the network device.

3. A method according to claim 1, wherein the identification of the type of the network device comprises:
sending an SNMP request to the network device on the managed network; and
receiving an SNMP response from the network device, wherein the identification of the type of the network device is based on the SNMP response.

4. A method according to claim 1, further comprising:
requesting, from the network device, data corresponding to an SNMP sysDescr variable for the network device, wherein the identification of the type of network device is based on the sysDescr variable.

5. A method according to claim 1, wherein the request to monitor the extracted SNMP variables of the network device comprises an SNMP request, the method further comprising:
receiving an SNMP response, from the network device, corresponding to the SNMP request;
receiving an SNMP request from a monitoring apparatus; and
generating, in response to the SNMP request from the monitoring apparatus, an SNMP response in accordance with the received SNMP response from the network device.

6. A method according to claim 1, further comprising:
receiving a device file for each of the network device types supported by the managed network, wherein each device file is compiled from an SNMP management information base (MIB) file for the respective network device type;
receiving a selection of one or more network devices to be monitored based on a selection of respective device files; and
receiving a selection of SNMP variables for each of the network devices to be monitored; and
wherein the one or more configuration files are generated based on the selected SNMP variables for each of the network devices to be monitored.

7. A method according to claim 6, wherein the selection of SNMP variables for each of the network devices to be monitored is based on parsed data from the selected respective device files.

8. A method according to claim 2, further comprising:
receiving a device file for each of the network device types supported by the managed network, wherein each device file is compiled from an SNMP management information base (MIB) file for the respective network device type;
receiving a selection of one or more network devices to be monitored and/or configured based on a selection of respective device files; and
receiving a selection of SNMP variables for each of the network devices to be monitored and/or configured; and
wherein the one or more configuration files are generated based on the selected SNMP variables for each of the network devices to be monitored and/or configured.

9. A method according to claim 8, wherein the selection of SNMP variables for each of the network devices to be monitored and/or configured is based on parsed data from the selected respective device files.

10. A method according to claim 1, wherein the one or more configuration files have been updated to include a list of one or more new network device types supported by the managed network and a listing of one or more respective SNMP variables for each of the new network device types, the method further comprising:
identifying a further network device on the managed network as a one of the new network device types listed the configuration file;
extracting the respective listing of SNMP variables to be monitored from the one or more configuration files for the identified new network device type; and
generating a request to monitor the extracted SNMP variables to be monitored for the further network device.

11. A method according to claim 2, wherein the one or more configuration files have been updated to include a list of one or more new network device types supported by the managed network and a listing of one or more respective SNMP variables for each of the new network device types, the method further comprising:
identifying a further network device on the managed network as a one of the new network device types listed the configuration file;
extracting the respective listing of SNMP variables to be monitored and/or configured from the one or more configuration files for the identified new network device type; and
generating a request to monitor and/or configure the extracted SNMP variables to be monitored and/or configured for the further network device.

12. An apparatus comprising:
at least one processor; and
at least one memory including computer program code for one or more programs, the at least one memory and the computer program code configured to, with the at least one processor, cause the apparatus to perform at least the following,
identify a network device on a managed network, wherein the network device is identified as a one of a list of one or more network device types supported by the managed network and included in one or more configuration files, and wherein the one or more configuration files further include a list of one or more respective SNMP variables to be monitored for each of the network device types;
extract the respective listing of SNMP variables to be monitored from the one or more configuration files for the identified network device type; and
generate a request to monitor the extracted SNMP variables to be monitored for the network device.

13. An apparatus according to claim 12, wherein the one or more configuration files further include a listing of one or more respective SNMP variables to be configured for each of the network device types listed in the configuration file, and wherein the apparatus is further caused to:
extract the respective listing of SNMP variables to be configured from the one or more configuration files for the identified network device type; and
generate a request to configure the extracted SNMP variables to be configured for the network device.

14. An apparatus according to claim 12, wherein the identification of the type of the network device comprises:
sending an SNMP request to the network device on the managed network; and
receiving an SNMP response from the network device, wherein the identification of the type of the network device is based on the SNMP response.

15. An apparatus according to claim 12, wherein the apparatus is further caused to:
request, from the network device, data corresponding to an SNMP sysDescr variable for the network device, wherein the identification of the type of network device is based on the sysDescr variable.

16. An apparatus according to claim 12, wherein the request to monitor the extracted SNMP variables of the network device comprises an SNMP request, and wherein the apparatus is further caused to:
receive an SNMP response, from the network device, corresponding to the SNMP request;
receive an SNMP request from a monitoring apparatus; and
generate, in response to the SNMP request from the monitoring apparatus, an SNMP response in accordance with the received SNMP response from the network device.

17. An apparatus according to claim 12, wherein the one or more configuration files have been updated to include a list of one or more new network device types supported by the managed network and a listing of one or more respective SNMP variables for each of the new network device types, and wherein the apparatus is further caused to:
identify a further network device on the managed network as a one of the new network device types listed the configuration file;
extract the respective listing of SNMP variables from the one or more configuration files for the identified new network device type; and
generate a request to monitor the extracted SNMP variables to be monitored for the further network device.

18. An apparatus according to claim 13, wherein the one or more configuration files have been updated to include a list of one or more new network device types supported by the managed network and a listing of one or more respective SNMP variables for each of the new network device types, and wherein the apparatus is further caused to:
identify a further network device on the managed network as a one of the new network device types listed the configuration file;
extract the respective listing of SNMP variables to be monitored and/or configured from the one or more configuration files for the identified new network device type; and
generate a request to monitor and/or configure the extracted SNMP variables to be monitored and/or configured for the further network device.

19. A system comprising:
a local device, wherein the local device comprises at least one processor, and at least one memory including computer program code for one or more programs, the at least one memory and the computer program code configured to, with the at least one processor, cause the local device to perform at least the following,
identify a network device on a managed network, wherein the network device is identified as a one of a list of one or more network device types supported by the managed network and included in one or more configuration files, and wherein the one or more configuration files further include a list of one or more respective SNMP variables to be monitored and/or configured for each of the network device types,
extract the respective listing of SNMP variables to be monitored and/or configured from the one or more configuration files for the identified network device type, and
generate a request to monitor and/or configure the extracted SNMP variables to be monitored and/or configured for the network device; and
a network manager device, wherein the network manager device comprises at least one processor, and at least one memory including computer program code for one or more programs, the at least one memory and the computer program code configured to, with the at least one processor, cause the local device to perform at least the following,
receive a device file for each of the network device types supported by the managed network, wherein each device file is compiled from an SNMP management information base (MIB) file for the respective network device type;
receive a selection of one or more network devices to be monitored and/or configured based on a selection of respective device files;
receive a selection of SNMP variables for each of the network devices to be monitored and/or configured; and
generate the configuration file based on the selected SNMP variables for each of the network devices to be monitored and/or configured.

20. A system according to claim 19, wherein the selection of SNMP variables for each of the network devices to be monitored and/or configured is based on parsed data from the selected respective device files.

21. A system according to claim 19, wherein the one or more configuration files have been updated to include a list of one or more new network device types supported by the managed network and a listing of one or more respective SNMP variables for each of the new network device types, and wherein the local device is further caused to:
identify a further network device on the managed network as a one of the new network device types listed the configuration file;
extract the respective listing of SNMP variables to be monitored and/or configured from the one or more configuration files for the identified new network device type; and
generate a request to monitor and/or configure the extracted SNMP variables to be monitored and/or configured for the further network device.
